(19) United States
(12) Patent Application Publication
(10) Pub. No.: US 2026/0287055 A1
(43) Pub. Date: Sep. 24, 2026

(54) PLANETARY TRANSMISSION STAGE AND ELECTRIC DRIVE SYSTEM

(71) Applicant: MERCEDES-BENZ GROUP AG, Stuttgart (DE)

(72) Inventors: Tobias SCHILDER, Ludwigsburg (DE); Tobias HAERTER, Stuttgart (DE); Cornelius HENTRICH, Waiblingen (DE); Philip KONOWALCZYK, Tübingen (DE)

(21) Appl. No.: 19/122,327

(22) PCT Filed: Sep. 29, 2023
(86) PCT No.: PCT/EP2023/077164

§ 371 Date: Apr. 18, 2025

(30) Foreign Application Priority Data
Oct. 20, 2022 (DE) 10 2022 003 888.9

(51) Int. Cl. F16H 57/08; B60K 1/00

(52) U.S. Cl. CPC F16H 57/082; B60K 1/00; F16H 2057/085

(57) ABSTRACT

A planetary transmission stage includes a sun gear, a planetary carrier and corresponding planetary gears, and a ring gear. The planetary carrier has a web and planetary gear bolts connected to the web in a rotationally fixed manner. In each case one of the planetary gears is rotatably mounted on one of the planetary gear bolts. The planetary carrier is a one-piece forged part.

### BACKGROUND AND SUMMARY OF THE INVENTION

Exemplary embodiments of the invention relate to a planetary transmission stage, as well as to an electric drive system for a motor vehicle with such a planetary transmission stage.

Planetary transmission stages, which can be used in an electric drive system for a motor vehicle, for example, are known from the prior art. Purely by way of example, reference can be made here to DE 10 2019 114 139 B3, which shows a motor vehicle transmission for coupling an electric engine to a drive train.

With regard to the planetary transmission stage itself, reference can furthermore be made to DE 10 2018 211 491 A1. Here, an arrangement for mounting an output shaft formed as a web shaft of a planetary gear set is described. Here, the construction shows a very complex planetary bearing made of numerous components and bearing elements for axial support and a nail bearing for radial support formed separately to this. Here, the construction is extremely complex to manufacture and accordingly expensive and difficult to assemble.

DE 10 2009 037 005 A1 and DE 195 36 177 C2 each show a planetary transmission stage in which a planetary carrier, which has a web and planetary gear bolts, is formed in one piece and as a forged part.

JP S61-17 562 U, DE 10 2019 218 440 A1, DE 10 2019 109 616 A1, DE 10 2019 123 264 A1, DE 10 2017 114 480 A1 and DE 10 2016 208 827 A1 each show further relevant prior art for forming planetary carriers.

Exemplary embodiments of the present invention are directed to an improved planetary transmission stage and an improved electric drive system with such a planetary transmission stage.

The planetary transmission stage comprises a sun gear, a planetary carrier with associated planetary gears and a ring gear, wherein the sun gear, planetary carrier, and ring gear are arranged to be able to be rotated around a main axis of rotation and thus all coaxially to this. Here, the planetary carrier itself has a web and planetary gear bolts connected to the web in a rotationally fixed manner, wherein the individual planetary gears are rotatably mounted on these planetary gear bolts. A special feature already known from the prior art lies in the area of the planetary carrier. This is designed as a one-piece forged part, which comprises both the web and the planetary gear bolts. Such a forged part allows high mechanical strength with good manufacturability and is preferable as a one-piece component.

According to the invention, a web cover is provided, which is respectively welded to the planetary gear bolts on a side facing away from the web. In this particularly favorable design, the one-piece construction of the forged part is thus completed by a web cover at the opposite end of the planetary gear bolts. This web cover is welded to the planetary gear bolts in order to thus complete the construction of the planetary carrier simply and efficiently.

Furthermore, according to the invention, it is provided that planetary gear bearing devices are used that are each arranged coaxially to one of the planetary gear bolts, wherein the web cover has first web cover rings, wherein in each case one of the first web cover rings is arranged coaxially to one of the planetary gear bolts. The respective first web cover ring is here arranged radially inside and axially overlapping with the respective planetary gear bearing device in relation to a planetary gear axis of rotation of the planetary gear of the corresponding planetary gear bolt. The planetary gear bearings or the planetary gears with their planetary gear bearing devices are thus located between the web on one side of the planetary gear bolts and the web cover on the other side of the planetary gear bolts, which respectively has the first web cover ring in the region of the planetary gear bolts. In the context depicted here, the terms coaxial, radial and axial refer to the planetary gear axis of rotation of the planetary gear.

Furthermore, according to the invention, a second planetary carrier bearing is provided, which is arranged coaxially to the main axis of rotation. This second planetary carrier bearing here supports the web cover directly, i.e., without further elements in between, radially in relation to a second housing ring.

Furthermore, according to the invention, it is provided that this second planetary carrier bearing is arranged radially inside a second web cover ring and radially outside the second housing ring. The web cover is thus supported on the second housing ring from the outside via the bearing when seen in the radial direction.

Furthermore, according to the invention, it is provided that the first web cover rings, which are formed to interact with the planetary gear bolts, and the second web cover ring, which is formed to interact with the planetary carrier bearing, are formed in axially different directions in relation to an axial center of the web cover. The first web cover rings thus protrude in the one axial direction, for example, in particular in the direction of the planetary gear bolts beyond a central plane of the web cover, while the second web cover ring protrudes in the opposite axial direction, i.e., the direction facing away from the web of the planetary carrier beyond the central plane of the web cover in the axial direction.

According to a very advantageous development of this, it can here be provided that a weld seam for welding the web cover and planetary gear bolt is respectively arranged between the first web cover ring and the planetary gear bolt. The web cover ring, which provides a sufficiently thick material, can thus be easily and efficiently welded to the planetary gear bolt.

The planetary carrier here has a first axial contact surface formed to respectively secure one of the planetary gear bearing devices axially in a first direction. Furthermore, in this advantageous design, it may be provided that the first web cover rings each have a second axial contact surface, which is formed to respectively secure one of the planetary gear bearing devices axially in a second direction. The planetary gear bearing device is thus secured between a contact surface of the planetary gear carrier, for example in the region of the web and/or the respective planetary gear bolt, on the one hand and the second axial contact surface in the region of the web cover on the other hand. Preferably, the planetary gear bearing devices together with the planetary gears can thus now be slid onto the planetary gear bolts and secured with the web cover. If the web cover is here pressed onto the planetary gear carrier or web with a certain compressive force, the required preload of the planetary gear bearing devices can here be achieved. In this preloaded state of the planetary bearing devices with the correct bearing tension, the welding of the web cover to the planetary gear bolt is then carried out. This is extremely simple and efficient and enables a planetary carrier with few components that is cost-effective to manufacture and easy to mount.

A further very advantageous design of the planetary transmission stage according to the invention further provides that a first planetary carrier bearing is arranged radially inside a carrier ring of the planetary carrier and radially outside a first housing ring arranged coaxially to the main axis of rotation. The terms coaxial, axial, and radial thus refer here to the axis of rotation of the planetary carrier, which is simultaneously the main axis of rotation of the planetary transmission stage.

The planetary bearing devices can fundamentally here be realized in different ways. For example, they can be designed as glide bearings or roller bearings. Here, for example, a single roller bearing for each of the planetary gears on the corresponding planetary gear bolt is a suitable solution with optimized friction behavior. According to a very advantageous development of the planetary transmission stage according to the invention, however, it can now also be provided that each of the planetary gear bearing devices has two bearings between the respective planetary gear bolt and the respective planetary gear. Such a design with two bearings allows the planetary gears to be supported spaced apart in the axial direction. Here, preferably, the two bearings can be formed in the form of angular contact ball bearings, which are formed to be spaced apart in the axial direction between the respective planetary gear bolt and the respective planetary gear. Two such angular contact ball bearings can be used to realize an ideal bearing arrangement with both axial and radial support in the respective bearing.

According to an extraordinarily favorable development of the above-mentioned variant of the planetary carrier bearings and also of this variant of the invention, it can furthermore be provided here that the two pairs of angular contact ball bearings are each arranged in an O-arrangement in relation to their axis of rotation. Here, the bearings of each pair are installed in such a way that the pressure lines of the two angular contact ball bearings running around the same axis of rotation run outwards, such that their points of intersection with the respective axis of rotation are arranged to be spaced further apart in the axial direction than the bearings themselves. This construction is typically referred to as an O-arrangement and here allows a bearing arrangement with ideal support.

The electric drive system according to the invention for a motor vehicle now comprises an electric engine with a rotor and an output shaft, which is connected, for example, to a directly driven gear or an axle drive, such as a differential, for example. Furthermore, with the electric drive system for the motor vehicle, a planetary transmission stage in one of the design variants described above is provided. Here, the rotor of the electric engine is connected or can be connected to the sun gear in a torque-transmitting manner. The ring gear is connected or can be connected to a housing in a rotationally fixed manner. A rotationally fixed connection in the sense of the invention is here to be understood to mean the connection of two coaxial elements in such a way that they rotate at the same angular velocity. The planetary carrier itself now forms the output and is connected to the output shaft in a rotationally fixed manner. All in all, the use of the planetary transmission stage with the particularly efficient planetary carrier results in a compact and, in terms of manufacture and assembly, simple and thus cost-efficient construction of such an electric drive system for a motor vehicle.

Preferably, the electric drive system is formed to drive exactly one gear of the motor vehicle, such that an electrically driven axle of the motor vehicle preferably has two electric drive systems according to the invention, which are arranged mirror-symmetrically to each other.

Further advantageous designs of the planetary transmission stage and the electric drive system for a motor vehicle also emerge from the exemplary embodiments, which are described in more detail below with reference to the figures.

### BRIEF DESCRIPTION OF THE DRAWING FIGURES

Here are shown:

FIG. 1 a schematic depiction of an electric drive system for a motor vehicle in an embodiment according to the invention;

FIG. 2 a sectional depiction of a cut-out of the electric drive system with an implementation of the planetary transmission stage according to the invention; and

FIG. 3 a schematic three-dimensional depiction of a planetary transmission stage according to the invention with a view of a web cover of a planetary carrier.

### DETAILED DESCRIPTION

An electric drive system 1 is shown schematically in FIG. 1. It has an electric engine 2, which is preferably formed here as an axial flow machine. This comprises a stator 30, which is arranged in a rotationally fixed manner in relation to a housing 5, and a two-part rotor 3, which is connected to a rotor shaft 4 in a rotationally fixed manner. The rotor shaft 4 forms an input shaft into a planetary transmission stage 13 and is connected to a sun gear 11 in a rotationally fixed manner. Moreover, the planetary transmission stage 13 comprises a ring gear 12, which is connected to the housing 5 in a rotationally fixed manner. A planetary carrier 8 is connected to an output shaft 18 in a rotationally fixed manner, which discharges power from the electric drive system 1, as is depicted by the output labelled with 7 and indicated by an arrow in the depiction of FIG. 1.

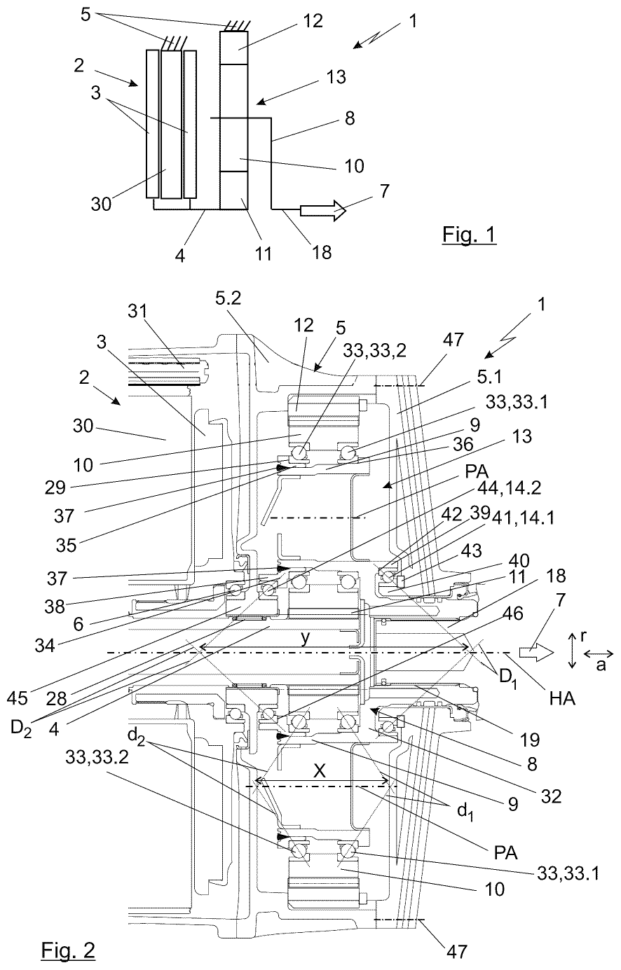

In the depiction of FIG. 2, a sectional depiction of the electric drive system 1 is depicted in a cut-out. The rotor 3, of which only the half to the right in the electric engine 2 or to the right of the stator 30 is correspondingly depicted here, is mounted in relation to a housing 5 via a roller bearing 6. It is connected to the rotor shaft 4 in a rotationally fixed manner, which is designed in several parts. The rotor shaft 4 is mounted indirectly via the roller bearing 6 of the rotor 3, which is designed as an angular contact ball bearing, and is furthermore supported on the housing via a needle bearing 28. On a side of the planetary transmission stage 13 facing away from the electric engine 2 in an axial direction a, the output 7 to a gear of the motor vehicle or an axle drive—e.g., a differential—is depicted schematically. Here, this output 7 is connected in a rotationally fixed manner via the output shaft 18 to a planetary gear carrier 8 as an output element of the planetary transmission stage 13 by means of splines labelled with 19.

The planetary carrier 8 thus comprises the planetary gear bolts 9 and a web 32, wherein the planetary gear bolts 9 are connected to the web 32 in a rotationally fixed and axially fixed manner. In the exemplary embodiment depicted here, the planetary gears 10 together with the two angular contact ball bearings 33.1 and 33.2, which together form the planetary gear bearing device 33, are mounted on the planetary gear bolts 9. Alternatively, a single roller bearing could also be provided, for example.

Here, the planetary carrier 8 made of the web 32 and the planetary gear bolt 9 is preferably designed as a one-piece forged part. Once the planetary gears 10 and the planetary gear bearing devices 33, here in the form of the two angular contact ball bearings 33.1, 33.2, have been fitted, a web cover 34 is now fitted on the side of the planetary gear bolts 9 facing away from the web 32. In the region of the respective planetary gear bolt 9, this web cover 34 respectively has a first web cover ring 35, which comes to rest in the radial direction r, in relation to a planetary gear axis of rotation PA of the planetary gear 10, between the planetary gear bolt 9 and an inner ring of the angular contact ball bearing 33.2 facing towards the web cover 34. The other angular contact ball bearing 33.1 abuts in axial direction a on a first axial contact surface 36, which is formed on the planetary gear bolt 9 or by the web 32 of the planetary carrier 8. Accordingly, a second axial contact surface 29 for the inner ring of the second angular contact ball bearing 33.2 is formed in the region of the web cover 34. After fitting the planetary gears 10 with the two angular contact ball bearings 33.1, 33.2 in each case, a preload can now be applied to the planetary gear bearing device 33 by pressing the web cover 34 onto the planetary carrier 8. This allows the angular contact ball bearings 33.1, 33.2 to be brought to the required bearing preload. If this state has been reached, a continuous or discontinuous weld seam 37 running around the periphery of the planetary gear bolt 9 or the first web cover ring 35 is created between the web cover 34, and here in particular between the first web cover ring 35 and the planetary gear bolt 9. This weld seam 37 now ensures that the planetary carrier 8 together with the planetary gears 10 and their planetary gear bearing device 33 is completed by the web cover 34. Here, the construction is very simple and can be ideally assembled in terms of the required bearing preload by pressing on the web cover 34 before welding in order to complete the central construction of the planetary transmission stage 13 extremely efficiently.

Here, the two angular contact ball bearings 33.1, 33.2 of the planetary gear bearing device 33 are designed in such a way that the pressure lines d₁ of the one angular contact ball bearing 33.1 shown in the lower half of FIG. 2 and the pressure lines d₂ of the other angular contact ball bearing 33.2 intersect the planetary gear axis of rotation PA of the planetary gear 10 shown below at a distance apart x which is greater than the distance apart between the two angular contact ball bearings 33.1 and 33.2 in axial direction a. This construction is also commonly referred to as an O-arrangement.

The planetary carrier 8 itself now has a first carrier ring 39 arranged coaxially to the main axis of rotation HA for its bearing arrangement, which is arranged in radial direction r outside a first housing ring 40 also arranged coaxially to the main axis of rotation HA. An angular contact ball bearing 14.1 is located between the first carrier ring 39 of the planetary carrier 8 and the first housing ring 40 of the housing 5 as the first planetary carrier bearing 41. Here, the angular contact ball bearing 14.1 supports both axial and radial forces, for which purpose a first axial surface 42 is provided on the web side and a setting disc 43 on the housing side, wherein the setting disc 43 for its part is supported on an unspecified axial surface of a housing cover 5.1 of the housing 5. An angular contact ball bearing 14.2 is also provided as the second planetary carrier bearing 44, which is arranged in the radial direction between a second housing ring 45 and the second web cover ring 38, which is also designed here as a second carrier ring for the bearing of the planetary carrier 8. The planetary carrier bearing 44 is supported on the web cover side on a second axial surface 46. On the side of the housing, support is provided on an axial surface of the second housing ring 45, which is not described in detail here.

The two angular contact ball bearings 14.1, 14.2 as the first and second planetary carrier bearings 41, 44 are now arranged in an O-arrangement, just like the two angular contact ball bearings 33.1 and 33.2 of the planetary gear bearing device 33, this time in relation to the main axis of rotation HA. This also means here that the pressure lines D₁ of the first angular contact ball bearing 14.1 and D₂ of the second angular contact ball bearing 14.2 intersect the main axis of rotation HA at a distance, designated here as y, which is greater than the distance between the bearings themselves in the same axial direction a. Here, the main axis of rotation HA is the common axis of rotation of the sun gear 11, the planetary carrier 8 and the ring gear 12.

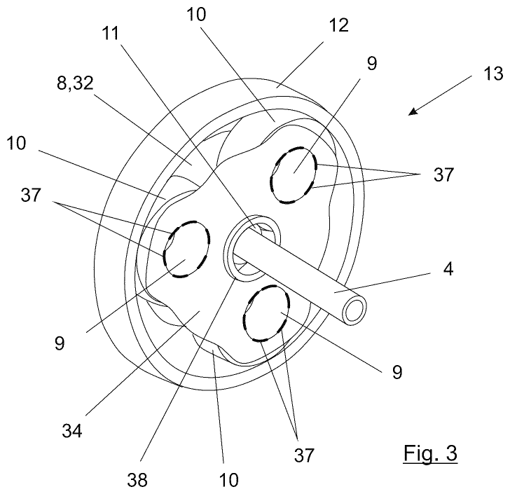

In the illustration in FIG. 3, the planetary transmission stage 13 can be seen again in a schematic 3D representation. Here, to simplify matters, the toothing is not depicted. FIG. 3 shows the ring gear 12 on the very outside as a ring, in which three planetary gears 10 rotate in the exemplary embodiment depicted here. The planetary carrier 8 or its web 32 can be seen largely concealed by the planetary gears 10. The planetary gear bolts 9 are arranged on these, on which the planetary gears 10 are correspondingly mounted. Here, the majority of the construction is visually concealed by the web cover 34, which is welded to the planetary gear bolt 9 via the weld seams 37 in the region of the first web cover rings 35, which are not explicitly recognizable here since they protrude inwards. The second web ring 38, via which the planetary carrier 8 is mounted on one of its axial sides, can be seen in the centrally in the region of the web cover 34. The sun gear 11 and the rotor shaft 4 can also be seen in the center of the construction in the depiction of FIG. 3, similar to the depiction of FIG. 2.

The bearing arrangement of the planetary transmission stage 13 as a whole is now designed in such a way that the planetary gear bearing device 33 is arranged in the axial direction between the two planetary carrier bearings 41, 44. As already mentioned above, the sun gear 11 is correspondingly mounted via the rotor shaft 4 and thus via the bearing 6 and the needle bearing 28 indicated in the region of the second housing ring 45. Here, a further bearing can be designed in the region of the second half of the rotor 3 on the other side of the electric engine 2 in axial direction a, which is no longer depicted here.

As already indicated, the housing 5 consists of the housing cover 5.1 and a portion 5.2 known as the lower part of the housing, which as such is designed in one piece. The entire construction is now mounted from the side of the housing cover 5.1 by first inserting the electric engine 2 and fixing its stator 30 correspondingly, for example via the indicated screw connection 31. The parts of the planetary transmission stage 13 are then inserted with the previously completed planetary carrier 8 made of web 32, planetary gears 10 and web cover 34. The bearing preload within the planetary bearing devices 33 has here already been set by pressing on and welding the web groove 34. The bearing preload for the two planetary carrier bearings 41, 44 can be correspondingly adjusted during assembly via the adjusting disc 43, since the second housing ring 45 is formed in the lower housing part 5.2 and the first housing ring 40 in the housing cover 5.1. Using a suitable adjusting disc 43, the bearing preload can thus be adjusted when fixing the housing cover 5.1, for example using the indicated screw connections 47 with the lower housing part 5.2 of the housing 5.

As has been mentioned above, the output shaft 18 can then be coupled to the planetary carrier 8 in a rotationally fixed manner via the splines 19 such that, for example, a single gear or an axle drive, such as in particular a differential of a motor vehicle, can be driven electrically via the output 7.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

List of reference numbers

| | |
|---|---|
| 1 | Electric drive system |
| 2 | Electric engine |
| 3 | Rotor |
| 4 | Rotor shaft |
| 5 | Housing |
| 5.1 | Housing cover |
| 5.2 | Housing lower part |
| 6 | Bearing (of the rotor) |
| 7 | Output |
| 8 | Planetary carrier |
| 9 | Planetary gear bolts |
| 10 | Planetary gears |
| 11 | Sun gear |
| 12 | Gear ring |
| 13 | Planetary transmission stage |
| 14.1 | Angular ball bearing of the first planetary carrier bearing |
| 14.2 | Angular ball bearing of the second planetary carrier bearing |
| 18 | Output shaft |
| 19 | Spines |
| 28 | Needle bearing |
| 29 | Second axial contact surface on the web cover |
| 30 | Stator |
| 31 | Screw connection of the stator |
| 32 | Web |
| 33 | Planetary gear bearing device |
| 33.1 | Angular ball bearing |
| 33.2 | Angular ball bearing |
| 34 | Web cover |
| 35 | First web cover ring |
| 36 | First axial contact surface on planetary gear bolts |
| 37 | Welded seam |
| 38 | Second web cover ring |
| 39 | First carrier ring |
| 40 | First housing ring |
| 41 | First planetary carrier bearing |
| 42 | First axial surface on the web |
| 43 | Setting ring |
| 44 | Second planetary carrier bearing |
| 45 | Second housing ring |
| 46 | Second axial surface on the web cover |
| 47 | Screw connections of the housing cover |
| a | Axial direction |
| D₁, D₂ | Pressure lines |
| d₁, d₂ | Pressure lines |
| HA | Main axis of rotation |
| PA | Planetary gear axis of rotation |
| r | Radial direction |
| X | Spacing apart |
| y | Spacing apart |

1-10. (canceled)

11. A planetary transmission stage comprising:
a sun gear;
a planetary carrier arranged rotatably around a main axis of rotation and corresponding planetary gears;
a ring gear, wherein the planetary carrier has a web and planetary gear bolts connected to the web in a rotationally fixed manner, wherein in each case one of the planetary gears is mounted rotatably on one of the planetary gear bolts, wherein the planetary carrier is a one-piece forged part;
a web cover respectively welded to the planetary gear bolts on a side facing away from the web;
planetary gear bearing devices, wherein in each case one of the planetary gear bearing devices is arranged coaxially to one of the planetary gear bolts, wherein the web cover has first web cover rings, wherein in each case one of the first web cover rings is arranged coaxially to one of the planetary gear bolts, wherein the respective first web cover ring is arranged radially inside and axially overlapping with the respective planetary gear bearing device with respect to a planetary gear axis of rotation of the planetary gear of the associated planetary gear bolt; and
a second planetary carrier bearing arranged coaxially to the main axis of rotation and supporting the web cover radially directly relative to a second housing ring, wherein the second planetary carrier bearing is arranged radially inside a second web cover ring and radially outside the second housing ring,
wherein the first web cover rings and the second web cover ring are formed on the web cover in axially opposite directions, and
wherein the planetary carrier has in each case a first axial contact surface formed to secure in each case one of the planetary gear bearing devices axially in a first direction.

12. The planetary transmission stage of claim 11, further comprising:
a weld seam welding the web cover and planetary gear bolt is arranged in each case between the first web cover ring and the planetary gear bolt.

13. The planetary transmission stage of claim 11, wherein the first web cover rings each have a second axial contact surface arranged to secure in each case one of the planetary gear bearing devices axially in a second direction.

14. The planetary transmission stage of claim 11, further comprising:
a first planetary carrier bearing arranged radially inside a first carrier ring of the planetary carrier and radially outside a first housing ring arranged coaxially to the main axis of rotation.

15. The planetary transmission stage of claim 14, wherein the first planetary carrier bearing has a first angular contact ball bearing and the second planetary carrier bearing has a second angular contact ball bearing.

16. The planetary transmission stage of claim 11, wherein each of the planetary gear bearing devices comprises two bearings between the respective planetary gear bolt and the respective planetary gear.

17. The planetary transmission stage of claim 16, wherein the two bearings are angular contact ball bearings arranged spaced apart in the axial direction between the respective planetary gear bolt and the respective planetary gear.

18. The planetary transmission stage of claim 17, wherein at least one of the two pairs of angular contact ball bearings of the planetary gears or of the planetary carrier are arranged in an O-arrangement with respect to their respective axis of rotation.

19. An electric drive system for a motor vehicle, the electric drive system comprising:
an electric engine having a rotor;
an output shaft; and
a planetary transmission stage comprising
a sun gear;
a planetary carrier arranged rotatably around a main axis of rotation and corresponding planetary gears;
a ring gear, wherein the planetary carrier has a web and planetary gear bolts connected to the web in a rotationally fixed manner, wherein in each case one of the planetary gears is mounted rotatably on one of the planetary gear bolts, wherein the planetary carrier is a one-piece forged part;
a web cover respectively welded to the planetary gear bolts on a side facing away from the web;
planetary gear bearing devices, wherein in each case one of the planetary gear bearing devices is arranged coaxially to one of the planetary gear bolts, wherein the web cover has first web cover rings, wherein in each case one of the first web cover rings is arranged coaxially to one of the planetary gear bolts, wherein the respective first web cover ring is arranged radially inside and axially overlapping with the respective planetary gear bearing device with respect to a planetary gear axis of rotation of the planetary gear of the associated planetary gear bolt; and
a second planetary carrier bearing arranged coaxially to the main axis of rotation and supporting the web cover radially directly relative to a second housing ring, wherein the second planetary carrier bearing is arranged radially inside a second web cover ring and radially outside the second housing ring,
wherein the first web cover rings and the second web cover ring are formed on the web cover in axially opposite directions,
wherein the planetary carrier has in each case a first axial contact surface formed to secure in each case one of the planetary gear bearing devices axially in a first direction,
wherein the rotor is connected or connectable in a torque-transmitting manner to the sun gear, wherein the ring gear is connected or connectable in a rotationally fixed manner to a housing, and wherein the planetary carrier is connected in a rotationally fixed manner to the output shaft.
